(19) United States
(12) Patent Application Publication
(10) Pub. No.: US 2015/0269329 A1
(43) Pub. Date: Sep. 24, 2015

(54) Living Community with Health Care Services

(71) Applicants: Roger E. Fearon, Houston, TX (US); Timothy Leppard, Houston, TX (US); Jeffrey M. Carlitz, Houston, TX (US)

(72) Inventors: Roger E. Fearon, Houston, TX (US); Timothy Leppard, Houston, TX (US); Jeffrey M. Carlitz, Houston, TX (US)

(21) Appl. No.: 14/223,656

(22) Filed: Mar. 24, 2014

(51) Int. Cl. G06F 19/00

(52) U.S. Cl. CPC G06F 19/327

(57) ABSTRACT

A living community, organization of the living community and method of providing medical care to individuals of the living community are disclosed. The living community includes a residence for an individual. An individual living in the living community is enrolling in health care plan based on the individual residing at the residence of the community. Medical care is provided to the individual enrolled in the health care plan to enable the individual to maintain living at the residence during an illness. An organization of the living community may implement and administer the health care plan to the individual.

### BACKGROUND OF THE DISCLOSURE

1. Field of the Disclosure

The present application is related to providing health care and, in particular, to a living community for providing health care to an individual having residence within the living community.

2. Description of the Related Art

Active Adult Communities are housing communities that are historically targeted for people in a selected age range, usually for people ages 55 years old and higher. To become a resident of an Active Adult Community, an individual generally purchases a residence in the Active Adult Community and thereby enters into an agreement with a Home Owner's Association (HOA) that serves the Active Adult Community. In the agreement, the HOA maintains the properties of various housing units and provides lifestyle and cultural activities for the resident as well as amenities such as leisure activities, community meeting centers, etc. While people in the age range of 55 years and older may be at increased health risk and experience proportionately more health problems, Active Adult Communities do not provide health care to its residents. Often, when an individual living in an Active Adult Community experiences a health crisis or emergency, that individual is interred in a hospital and then moved to a long-term acute care facility until they are considered able to take care of themselves, at which time they may return to their residence in the community. If the illness or health crisis is serious enough, the individual may be, for example, moved to an independent living center or to an assisted living center to live out the remainder of his or her days. Such assisted living centers are typically costly and still do not provide health care to its residents, contrary to popular belief.

### SUMMARY OF THE DISCLOSURE

In one aspect, the present disclosure provides a method of providing medical care to an individual, the method including: providing a living community including a residence; enrolling the individual in a health care plan based on the individual residing at the residence of the community; and providing the medical care to the individual enrolled in the health care plan to enable the individual to maintain living at the residence during an illness.

In another aspect, the present disclosure provides a living community, including: a residence within the living community for housing an individual; an organization of the living community configured to provide a health care plan for the individual that enables the individual to maintain living at the residence during an illness.

In yet another aspect, the present disclosure provides an organization for operating to a living community, the organization including: a health care management group configured to administer a health care plan to an individual living at a residence within the living community in order to enable the individual to continue living at the residence during an illness.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

The present disclosure is best understood with reference to the accompanying FIGURES in which like numerals refer to like elements and in which:

FIG. 1 shows a schematic diagram of a living community that implements health care to residents of the living community.

### DETAILED DESCRIPTION OF THE DISCLOSURE

The present disclosure provides a living community and method and organization for operating a living community that provides health care or a suite of health care plans to its residents or individuals living within the living community. The method disclosed herein allows an individual to “age in place” such that an illness or health emergency does not impact his or her home ownership or living arrangement. In one embodiment, health care services may be provided to the individual at his or her place of residence within the living community. The health care services may be provided to the individual based on an agreement, arrangement, contract or a rider to a contract that the individual enters into upon joining the living community or taking up residence within the living community.

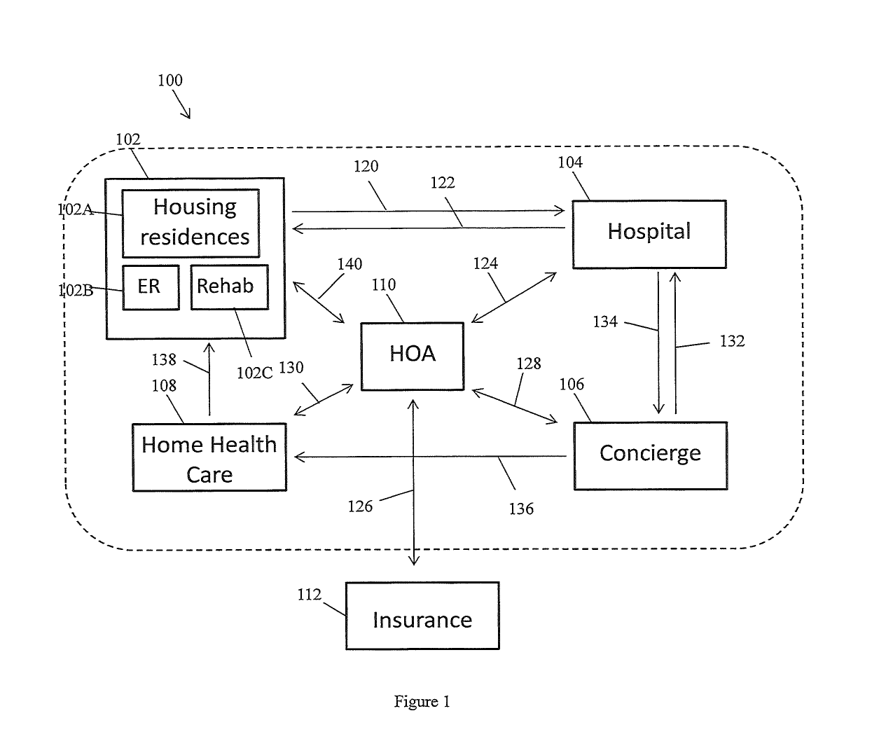

FIG. 1 shows a schematic diagram of a living community 100 that implements health care to residents of the living community 100. A living community 100 may refer to any community or collection of residences that are centered on a residence agreement. In general, the living community 100 provides amenities to an individual (also referred to as a “resident”) of its community, such as leisure activities, etc. In one embodiment of the present disclosure, the living community includes an Active Adult Living community. An Active Adult Living community is an age-targeted living community (such as for individuals 55 years old and up) that includes campus 102 with housing units 102A or properties that are maintained by an organization such as a Home Owner's Association 110. The housing units 102A may range from detached houses to townhomes, condominiums or apartments or a combination thereof, in various embodiments. The Home Owner's Association 110 may further provide leisure and other activities to residents of the living community 100.

A living community may further comprise a specialty community build by the developer or by a third party, a pre-existing living community or development. Alternatively, a living community may comprise a collection of predetermined demarcated areas such as census blocks, census tracts, zip codes, roads or natural boundaries that are logically grouped together to form a service area which defines the living community. This logical grouping may contain existing subdivisions which are not related to each other and which have their own existing Home Owner's Associations but which can be brought together, in part or in whole, under the Home Owner's Association 110 of the present disclosure. These logical groupings may be joined separate and apart from any existing legal structure.

In one embodiment, the living community 100 includes a residential campus 102 with housing units 102A, a hospital 104, a concierge doctor's group 106 and a home health care group 108. The campus 102 may further include various health centers, such as an emergency room (ER) 102B and/or a rehabilitation center (Rehab) 102C, either of which may be associated with the hospital 104. The hospital 104, concierge document group 106 and home health care group 108 are in partnership with the HOA 110, which is to say they have a business agreement with the HOA 110. In the partnership, the home owner's association (HOA) 110 may provide, implement and coordinate a health care plan to residents of the living community 100 through its association with the hospital 104, concierge document group 106 and home health agency 108. The health care plan may include various health care services such as emergency room services, operating room services, clinical services, outpatient services, nursing and home-nursing services, etc. to residents of the living community 100. In one embodiment, the individual may enter into the health care plan of the living community upon taking up residence within the living community 100. The health care plan may be provided, for example, as part of the housing agreement as a rider to a contract signed by the individual to join the living community 100. If the resident already has a home healthcare/longterm care plan, the resident may choose to keep his or her plan.

The health care plan of the living community 100 may enable its residents to maintain his or her residence within the living community 100 during a health emergency, long-term acute illness or chronic illness, or an illness that is incapacitating to the individual, as discussed below. The duration of the illness may include the time for the onset of the illness, such as a heart attack or stroke until a time at which the individual is able to resume a normal operating functionality at his or her housing unit 102A. This duration includes time spent in the hospital 104 as well as a convalescence time that may be spent at the housing unit 102A of the resident with the assistance of the home health agency 108. Thus, the living community of the present invention provides health services that prevent or reduce the probability that the individual has to move to a nursing home or assisted living center during his or her illness. This arrangement lowers the cost of health care to the resident of the living community 100.

In one embodiment, the health care plan may include long-term care insurance (LTC) to individuals in the living community 100. LTC is an insurance product that helps provide for the cost of long-term care extending beyond a predetermined shortened period of time such as specified in the terms of a standard health care insurance plans. For example, long-term care insurance covers health care that is generally not covered by health insurance, Medicare or Medicaid.

In various embodiments, the health of a patient may be assessed to select which health care services are to be provided to the patient. For example, the patient's health may be evaluated whether the individual can performed Basic Activities of Daily Living (BADL) and/or Instrumental Activities of Daily Living (IADL). A BADL may include: bathing and showering (washing the body), bowel and bladder management (recognizing the need to relieve oneself), dressing, eating (including chewing and swallowing), feeding (setting up food and bringing it to the mouth), functional mobility (moving from one place to another while performing activities), personal device care, personal hygiene and grooming (including brushing/combing/styling hair), and toilet hygiene (completing the act or urinating/defecating). IADLs include, for example, performing housework, taking medication as prescribed, managing money, shopping for groceries or clothing, use of telephone or other form of communication, using technology (as applicable), and transportation within the community.

Individuals who require long-term care are generally unable to perform some or all of the BADLs functions. In one embodiment, an individual not capable of performing BADLs functions may be eligible for release from a hospital 104 into the hands of the Concierge Doctor's Group 106 and/or the Home Healthcare Agency 108, as recommended by the Concierge Doctor's Grouop 106. After an individual becomes capable of IADLs, he or she may be deemed to be recovered from his or her health care emergency and therefore able to continue residence in his or her housing unit 102A. The disclosure therefore provides for daily eposidic home health care on an as-needed basis.

In one embodiment, the HOA 110 may partner with an insurance company 112 to provide a group health care plan to the living community 110. The group health care plan may be constructed so as to lower health care costs on a group cost basis for the living community 100 and its residents. The HOA 110 may provide or aid in adjudication of claims, thereby simplifying the adjudication process for members of the health care plan. The HOA 110 may act as a liaison between the various medical care providers (e.g., hospital 104, Concierge Doctor's Group 106 and Home health Care Group 108), the insurance company 112 and a resident of the living community 100.

In one aspect, the HOA 110 may partner with (or enter into an agreement) a regional hospital 104 or health care facility. The partnership with the hospital 104 allows the formation of concierge programs 108 to provide healthcare delivery for residents enrolled in the HOA 110. The hospital 104 may provide off-site health care, outpatient and inpatient services, emergency room and rehabilitation services, etc. The hospital 104 may operate on a concierge platform, meaning that the hospital 104 provides preferential treatment to residents enrolled in the health care plan. Preferential treatment may include, for example, preferential appointment bookings, minimizing wait times, increased assistance with radiology and other laboratory needs, etc. The hospital 104 may benefit from partnership with the HOA 110 by having a captive base of well-insured future patients that have a “patient point of entry” path already planned and future health care service lines outlined.

The hospital 104 may be either on-site (i.e., on the campus of the living community 100) or off-site. Alternatively, an extension of the hospital 104 may be on-site. By operating an emergency room 102B on the site of the living community 100, the hospital 104 may have a direct referral base from which to fill beds of the hospital 104. Profitability of the hospital 104 is determined by the payer type, not by a type of procedure performed.

As part of the agreement between the HOA 110 and the hospital 104, the hospital 104 may conduct scheduled disease screening and wellness programs in order to improve the health and longevity of the residents. This agreement may then be used to reduce HOA 110 insurance rates.

In another aspect, the HOA 110 may administer an outreach program to residents of the community to take advantage of medical billing assistance programs and to participate in the hospital concierge program. This will provide the living community 100 with a steady stream of residents when a resale comes up in the living community 100 and will provide to the associated hospital 104 to a consistent concierge pool of insured patients.

In another aspect, a Physicians Group such as the Concierge Doctor's Group 106 may partner with the HOA 110 to extend care to and from the hospital 104. The Physicians Group may be linked to the hospital 104 to provide a seamless continuum of care to the patients from when the resident enters into the hospital 104 until a time at which the resident is nursed back to health in his or her residence. If a resident has a preferred physician outside of the Physicians Group, the preferred physician may be incorporated into the Concierge Doctor's Group 106 via an out-of-network contract.

Finally, the HOA 110 may partner with a Home Health Care Group 108 that administers health care services to the individual at his/her residence. The Home Health Care Group 108 may be supervised by the HOA 110 and/or a selected medical director. The Home Health Care Group 108 provides services that “close the loop,” thereby keeping the resident out of a current for-rent senior housing system during any part of his or her illness.

A patient's progress through the health care plan of the present disclosure is now discussed. As shown by line 120, a resident experiences an illness or health emergency and is transferred from housing unit 102A to the hospital 104 (CLINIC). The resident, now referred to as a patient, may experience the services provided by the hospital 104, including emergency room services, operating room services, X-ray, MRI, etc. For an illness with a relatively quick turn-around time, the patient may be interred in the hospital for a few days and then returned (line 122) to his or her residence or housing unit 102A. Billing and insurance information may be provided from the hospital 104 to the HOA 110 (line 124). The HOA 110 in turn coordinates (line 126) insurance payments, etc. between the insurance company 112 and the medical care providers.

For a an acute illness, the patient may be referred (line 132) to the Concierge Doctor's Group (or Physician's Group) 106 which may provide personalized medical attention to the patient and prepare and administer the acute medical care to the patient through the hospital 104. The Concierge Doctor's Group 106 may determine medical care that may be administered as the patient progresses from the hospital bed to recovery at his or her own residence. The Concierge Doctor's Group 106 may coordinate (134) the patient's medical care with the hospital 104. The Concierge Doctor's Group 106 may also coordinate (line 128) billing and insurance information on the patient with the HOA 112.

Finally, as the patient returns to his or her residence for convalescence, the Concierge Doctor's Group 106 may hand off (line 136) the patient to the Home Health Care Group 108 for administering health care (line 138) to the individual in his or her own residence. The Home Health Agency 108 provides billing and insurance information to the HOA 112 (line 130) which coordinates insurance with the insurance company 112. Thus, the HOA coordinates billing and insurance between the insurance company (line 126), the medical care providers (lines 124, 128, 130) and the individual (140). The concierge medical group 106 may initiate the home health care service as a prescription order.

In another aspect, the present invention provides a method of providing a living community that allows a resident of the living community to maintain home ownership during a long term health illness. The invention includes forming a partnership between a living community, such as an Active Adult Community, and a medical institution or organization such as a hospital, doctor's clinic, rehabilitation group, pharmacy, Physician's Group/Concierge Doctor's Group 106 and/or a Home Health Care Agency 108 to provide health services to residents of the living community. The disclosure further includes providing or instituting a health care plan to the members of the living community that provides health care for long-term illnesses, chronic illness, health emergencies, etc., using the formed partnership the medical institution or organization. The partnership with the medical care providers therefore allows the individual to maintain living at his or her residence within the living community 100 during the entirety of his or her illness.

The hospital 104 and the Concierge Doctor's Group 106 may inhabit an Emergency Room 102B and Rehabilitation Center 102C built on the campus 102 of the living community 100 or in close proximity to the housing units 102A. The hospital 104 may build or lease the facilities from developers of the living community or from the HOA 110. Locating the Emergency 102B and/or Rehabilitation Center 102C on campus 102 gives the residents/patients quick access to emergency services and/or physical therapy services with limited need for transportation.

Thus, the present disclosure unites five previously separate and disparate products: residential living, hospital care, concierge physician services and home-health care and a home owner's association to adjudicate and advocate for the patient. The present disclosure may bring payer, and providers and patients together in an economical home-based geriatric care platform that will ultimately lower long-term healthcare costs for all involved. The coordination of the hospital, physician based care, insurance adjudication and home care services may be managed by the HOA and administered by each individual medical based HOA that is established.

Therefore in one aspect, the present disclosure provides a method of providing medical care to an individual, the method including: providing a living community including a residence; enrolling the individual in a health care plan based on the individual residing at the residence of the community; and providing the medical care to the individual enrolled in the health care plan to enable the individual to maintain living at the residence during an illness. In one embodiment, an organization is provided for controlling an operation of the living community, wherein the organization is configured to coordinate the health care plan to the individual. A partnership may be formed between the living community and a medical care provider to provide medical care to the individual enrolled in the health care plan. In various embodiments, the medical care provider provides at least one service selected from the group consisting of: (i) hospital care; (ii) emergency room service; (iii) operating room service; (iv) diagnostic service; (v) concierge doctor's service; (vi) services of a physician's group; (vii) home health care service; and (viii) rehabilitation services. In various embodiments, the illness may include: acute long-term illness; an illness that renders a patient incapable of at least one of Basic Activities of Daily Living; an illness that renders a patient incapable of at least one of Instrumental Activities of Daily Living; and/or an end-of-life illness. As part of the partnership, the medical care may be provided to the individual within the selected residence of the individual. In various embodiments, the living community is at least one of (i) an Active Adult Living community; (ii) an age-targeted living community; and (iii) a community served by a home owner's association. An organization may be provided for the living community to coordinate billing and insurance between the medical care provider, the individual and an insurance company of the resident.

In another aspect, the present disclosure provides a living community, including: a residence within the living community for housing an individual; an organization of the living community configured to provide a health care plan for the individual that enables the individual to maintain living at the residence during an illness. The organization may be in partnership with a medical care provider to provide medical care to the individual. In various embodiments, the medical care provider may include at least one of: (i) a hospital; (ii) a doctor's clinic; (iii) a concierge doctor's group; (iv) a physician's group; (v) a home health care group; and (viii) a rehabilitation clinic. In various embodiments, the illness may be an acute, long-term illness; an illness that renders a patient incapable of at least one of Basic Activities of Daily Living; an illness that renders a patient incapable of at least one of Instrumental Activities of Daily Living; and/or an end-of-life illness. The organization may coordinate with the medical care provider to provide the medical care to the individual within the residence of the individual. In various embodiments, the living community includes at least one of: (i) an Active Adult Living community; (ii) an age-targeted living community; and (iii) a living community in which the organization is provided by a home owner's association. The organization of the living community may also coordinate insurance and billing with the medical care provider and the individual.

In yet another aspect, the present disclosure provides an organization for operating to a living community, the organization including: a health care management group configured to administer a health care plan to an individual living at a residence within the living community in order to enable the individual to continue living at the residence during an illness. The health care management group may form a partnership with a medical care provider to provide the medical care to the individual. Furthermore, the health care management group may coordinate billing between the medical care provider, the individual and an insurance company that provides the health plan. In various embodiments, the illness is at least one of: (i) a long-term illness; (ii) an illness that renders a patient incapable of at least one of Basic Activities of Daily Living; (iii) an illness that renders a patient incapable of at least one of Instrumental Activities of Daily Living; and (iv) an end-of-life illness. In various embodiments, the living community is at least one of (i) an Active Adult Living community; (ii) an age-targeted living community; and (iii) a community served by a home owner's association.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method of providing medical care to an individual, comprising:
providing a living community including a residence;
enrolling the individual in a health care plan based on the individual residing at the residence of the community; and
providing the medical care to the individual enrolled in the health care plan to enable the individual to maintain living at the residence during an illness.

2. The method of claim 1, further comprising providing an organization for controlling an operation of the living community, wherein the organization is configured to coordinate the health care plan to the individual.

3. The method of claim 1, further comprising providing a partnership between the living community and a medical care provider to provide medical care to the individual enrolled in the health care plan.

4. The method of claim 3, wherein the medical care provider provides at least one service selected from the group consisting of: (i) hospital care; (ii) emergency room service; (iii) operating room service; (iv) diagnostic service; (v) concierge doctor's service; (vi) services of a physician's group; (vii) home health care service; and (viii) rehabilitation services.

5. The method of claim 1, wherein the illness further comprises at least one selected from the group consisting of: (i) a long-term illness; (ii) an illness that renders a patient incapable of at least one of Basic Activities of Daily Living; (iii) an illness that renders a patient incapable of at least one of Instrumental Activities of Daily Living; and (iv) an end-of-life illness.

6. The method of claim 1, further comprising providing the medical care to the individual within the selected residence of the individual.

7. The method of claim 1, wherein the living community is at least one of (i) an Active Adult Living community; (ii) an age-targeted living community; and (iii) a community served by a home owner's association.

8. The method of claim 3, further comprising providing an organization of the living community to coordinate billing and insurance between the medical care provider, the individual and an insurance company.

9. A living community, comprising:
a residence within the living community for housing an individual;
an organization of the living community configured to provide a health care plan for the individual that enables the individual to maintain living at the residence during an illness.

10. The living community of claim 9, wherein the organization is in partnership with a medical care provider to provide medical care to the individual.

11. The living community of claim 9, wherein the medical care provider further comprises at least one of: (i) a hospital; (ii) a doctor's clinic; (iii) a concierge doctor's group; (iv) a physician's group; (v) a home health care group; and (vi) a rehabilitation clinic.

12. The living community of claim 9, wherein the illness further comprises at least one selected from the group consisting of: (i) a long-term illness; (ii) an illness that renders a patient incapable of at least one of Basic Activities of Daily Living; (iii) an illness that renders a patient incapable of at least one of Instrumental Activities of Daily Living; and (iv) an end-of-life illness.

13. The living community of claim 9, wherein the organization coordinates with the medical care provider to provide the medical care to the individual within the residence of the individual.

14. The living community of claim 8, further comprising at least one of: (i) an Active Adult Living community; (ii) an age-targeted living community; and (iii) a living community in which the organization is provided by a home owner's association.

15. The living community of claim 10, wherein the organization of the living community is further configured to coordinate insurance and billing with the medical care provider and the individual.

16. An organization for operating to a living community, comprising:
a health care management group configured to administer a health care plan to an individual living at a residence within the living community in order to enable the individual to continue living at the residence during an illness.

17. The organization of claim 16, wherein the health care management group is further configured to form a partnership with a medical care provider to provide the medical care to the individual.

18. The organization of claim 17, wherein the health care management group is further comprising to coordinate billing between the medical care provider, the individual and an insurance company that provides the health plan.

19. The organization of claim 16, wherein the illness further comprises at least one selected from the group consisting of: (i) a long-term illness; (ii) an illness that renders a patient incapable of at least one of Basic Activities of Daily Living; (iii) an illness that renders a patient incapable of at least one of Instrumental Activities of Daily Living; and (iv) an end-of-life illness.

20. The organization of claim 16, wherein the living community is at least one of (i) an Active Adult Living community; (ii) an age-targeted living community; and (iii) a community served by a home owner's association.

21. The organization of claim 16, wherein the living community includes at least one of: (i) an emergency room facility; and (ii) a rehabilitation facility.
